(19) United States
(12) Patent Application Publication
(10) Pub. No.: US 2021/0168305 A1
(43) Pub. Date: Jun. 3, 2021

(54) LENS

(71) Applicant: RINO Technologies DMCC, Dubai (AE)

(72) Inventor: Antony James Holliday, York (GB)

(73) Assignee: RINO Technologies DMCC, Dubai (AE)

(21) Appl. No.: 16/902,348

(22) Filed: Jun. 16, 2020

(30) Foreign Application Priority Data
Nov. 28, 2019 (GB) 1917386.3

(51) Int. Cl. H04N 5/33; G02B 13/14; G01J 5/08; H04N 5/225

(52) U.S. Cl. CPC H04N 5/33; H04N 5/2254; G01J 5/0875; G02B 13/14

(57) ABSTRACT

An infrared transmitting lens for mounting in an aperture of a housing containing an apparatus to be subjected to infrared inspection, comprising a grille and an infrared transmitting material. The grille comprises a network of bars with an array of apertures between the bars, the grille providing mechanical protection to the infrared transmitting lens. The infrared transmitting material is positioned, in a combination of: on one, or both sides of the grille, or within the apertures of the grille; and thus enables infrared inspection through the array of apertures of the grille and through the infrared transmitting material. A method of manufacturing an infrared transmitting lens for mounting in an aperture of a housing containing an apparatus to be subjected to infrared inspection.

This present invention relates to an infrared transmitting lens, in particular, but not exclusively, to an infrared transmitting lens for use in a housing containing an apparatus that is subjected to infrared inspection. The present invention further relates to a method of manufacturing an infrared transmitting lens.

It is generally known to monitor engineering equipment, particularly electrical components, to maintain their performance and to identify and diagnose potential problems at an early stage. Typically, to carry out such monitoring, the equipment would be shut down and then accessed by an engineer or a mechanic who would restart the equipment and carrying out the required analysis on the equipment. A problem associated with this process is the likelihood of leading to prolonged periods of downtime, as well as health and safety risks on the personnel involved. It is known to instead use infrared cameras to monitor equipment. Another way of preventing prolonged periods of downtime and prevented health and safety risks is the use of a transparent window mounted to a frame or a port, through which components may be viewed. Such windows or ports must be provided with panes, or lenses, that are manufactured from materials which permit the transmission of electromagnetic radiation (ER) in the infrared (IR) wavelength range. This allows the contents within the equipment to be viewed through the windows or ports.

Typically, two kinds of infrared transparent lenses are used. The more common type is the use of a lens having a crystalline material. Crystalline (or crystal) lenses provide a good capability of visual and thermal inspection. However, these lenses have high costs associated with them. Costs are further driven up according to their capability of allowing infrared radiation to pass through them. That is, if a clear view through the lens is desired, a high quality is required, which often leads to high costs for materials and manufacture. Another drawback is the limited resistance to impact or adverse conditions in which they are subjected. Crystalline lenses are easy damaged or contaminated by dust or grease, which affects the accuracy of infrared measurements. Therefore, frequent monitoring or maintenance is required. Yet another drawback is the difficulty of manufacturing and processing associated with the use of crystalline. The difficulty of manufacturing and the nature of crystalline also results in limited shapes and sizes possible for crystalline infrared transmitting lenses made of crystalline. For example, it is difficult to make any other shape of crystalline lens other than a planar circle. Crystalline lenses tend not to be suitable for bending, or manufacturing into complex shapes.

Another type of transparent lens used, for infrared transmitting lenses, is one made from a polymer, or comprises a polymer. Polymeric lenses are typically manufactured from infrared transmitting polymer. Polymeric lenses are a cheaper alternative to the crystalline lens and can be made in shapes and sizes that crystalline lenses cannot be. Also, polymeric lenses typically must be thinner than crystalline in order to transmit infrared through the polymer sufficiently within the infrared spectrum. Typically, polymer lenses are in the range of about 0.2 millimetres to about 0.45 millimetres (mm) for infrared to be transmitted through the infrared transmitting material. As polymer infrared transmitting lenses must be thin, among other reasons, the polymeric infrared lenses typically lack mechanical strength, resistant to temperature and so also commonly suffer from penetrating damage.

It is an object of the invention to alleviate or mitigate at least one or more of the aforementioned problems. Particularly, it is desirable to provide an infrared transmitting lens having an improved capability of thermal inspection. It is also desirable to provide an infrared transmitting lens having a reduced cost of manufacture and having an increased resistance to contamination. It is further desirable to provide an infrared transmitting lens that is structurally strong, resistant to impact and hence having an improved resistance to being damaged. It is further desired to provide an infrared transmitting lens that is structurally strong but offer a greater choice of shapes and sizes possible of the lens over the prior art infrared transmitting lenses.

The present invention provides an infrared transmitting lens for mounting in an aperture of a housing containing an apparatus to be subjected to an infrared inspection, the infrared transmitting lens comprising:
a grille, the grille comprising a network of bars with an array of apertures between the bars, the grille providing mechanical protection to the infrared transmitting lens;
infrared transmitting material, positioned on both sides of the grille.

The present invention also provides an infrared transmitting lens for mounting in an aperture of a housing containing an apparatus to be subjected to an infrared inspection, the infrared transmitting lens comprising: a grille, the grille comprising a network of bars with an array of apertures between the bars; the grille further comprising infrared transmitting material, on two sides of the grille.

The grille may be generally planar comprising two sides. The grille may provide mechanical protection to the infrared transmitting material. The infrared transmitting material may enable infrared inspection through the array of apertures of the grille and through the infrared transmitting material. The grille may be generally planar having two sides, and an edge. The infrared transmitting material enabling infrared inspection through the array of apertures of the grille and through the infrared transmitting material.

The infrared transmitting material enabling infrared inspection through the array of apertures of the grille and through the infrared transmitting material. In some embodiments the infrared transmitting material may cover the apertures of the grille. In some embodiments the infrared transmitting material may cover the apertures of the grille on one side of the grille. In some embodiments the infrared transmitting material may cover the apertures of the grille of both sides of the grille.

An infrared transmitting lens for mounting in an aperture of a housing containing an apparatus to be subjected to infrared inspection, the infrared transmitting lens comprising:
a grille, the grille comprising a network of bars with an array of apertures between the network of bars; the grille further comprising infrared transmitting material, configured, at least partially, between the network of bars of the grille and at least partially filling the array of apertures between the network of bars of the grille.

In specific embodiments, when combined with other features, the grille further comprises infrared transmitting material, on one side of the grille.

In specific embodiments the infrared transmitting lens is provided with a grille comprising a network of bars having an array of apertures through which infrared inspection can be carried out. The presence of a grille further improves the strength and impact resistance of the lens, reducing the risks of the lens being damaged. Thus, there may be provided a lens which is capable of providing infrared thermal inspection, and which is structurally strong, resistant to impact and hence has resistance to damage. Thus, there may be provided a lens which is capable of allowing infrared transmitting therethrough the lens, and which is structurally strong, resistant to impact and hence has resistance to damage. In specific embodiments the infrared transmitting material is capable of allowing visual inspection, through the infrared transmitting material.

In some embodiments, the infrared transmitting material is at least partially positioned between the network of bars, at least partially filling the array of apertures between the network of bars of the grille. In some embodiments the grille comprises infrared transmitting material between the bars of the grille. In specific embodiments the apertures of the array of apertures of the grille are filled with infrared transmitting material. In specific embodiments the apertures of the array of apertures of the grille are sufficiently filled with infrared material that the infrared transmitting lens is fluid tight. In specific embodiments the grille further comprises infrared transmitting material. In specific embodiments the grille further comprises infrared transmitting material between the bars of the grille. In embodiments wherein the grille comprises infrared transmitting material, at least to some degree, between the network of bars and at least partially filling the array of apertures, infrared can be transmitted through the array of apertures of the grille, and through the infrared transmitting material.

In specific embodiments, the array of apertures of the grille are equal in size and shape, and arranged in a regular array.

In specific embodiments, the apertures of the grille are square, or circular; or rectangular; or triangular; or polygonal; or hexagonal; or any combination of square, circular, rectangular, triangular, polygonal or hexagonal.

In some embodiments, the array of apertures of the grille are arranged in a tessellation. In some embodiments the total area of a side of a grille, including bars and apertures is 0.129 metres square or less. For example, in specific embodiments the total area of a side of the grille, including bars and apertures is 0.5 metres square.

In specific embodiments, the infrared transmitting lens is planar. This is particularly advantageous since the infrared transmitting lens can be easily mounted within an aperture of the housing, placing the lens flush within the housing aperture. In specific embodiments the infrared lens is smooth on at least one surface. In specific embodiments the infrared transmitting material may be planar. In specific embodiments the infrared material may be flat. In specific embodiments the infrared material is flat on both sides. In specific embodiments the infrared material is flat on one side. In specific embodiments the infrared transmitting material is smooth on at least one side

In other embodiments, the infrared transmitting lens may instead be non-planar. In some embodiments, the infrared transmitting lens may be flat, or smooth, on one side and have protrusions on the other side. In specific embodiments the infrared transmitting material may be flat, or smooth, on one side and have protrusions on the other side. Aptly the protrusions may correspond to the apertures or spacing between the bars of the grille such that the infrared transmitting material fits between the bars of the grille. In embodiments wherein two infrared transmitting materials comprising protrusions on one side are used on either side of the grille, such that the protrusions face together, the protrusions may fit into the apertures, or spacing, between the bars of the grille. In specific embodiments with protrusions that correspond to the apertures, or spacing, between the bars of the grille, there may be corresponding indentations on the infrared material on the opposite side of the protrusions. Having corresponding protrusions and indentations enable the overall diameter of the infrared transmitting material to be less. This may be especially important when two infrared transmitting material sheets are used on either side of the grille.

In specific embodiments the infrared transmitting lens may be curved. In specific embodiments the infrared transmitting material is curved. For example, the infrared transmitting lens may have a curved arrangement or a bent shape. The infrared transmitting lens may also be shaped to correspond to the surface of the housing of the apparatus for infrared inspection. In the embodiments where the infrared transmitting lens is a curve, or a bent shape, infrared radiation may still be able to pass through the infrared transmitting lens.

Likewise for the transmitting infrared material, in specific embodiments the infrared material may be a curved arrangement or bent shape. The infrared transmitting material, in specific embodiments, may be configured in a curve. In specific embodiments the infrared transmitting material is semi-spherical. In specific embodiment the infrared transmitting material is round in shape.

In specific embodiments the grille may comprise a similar shape to the infrared transmitting material.

In specific embodiments, the grille comprises metal. In some specific embodiments the grille comprises aluminium or stainless steel, or both aluminium and stainless steel. The grille may comprise, for example, a different metal, such as titanium or copper; or a different material, for example, plastic; or metal coated with plastic; or any combination thereof. In some embodiments the grille may comprise plastic, for example KEVLAR, a Trade Name for a particular synthetic material or plastic. In specific embodiments the grille comprises glass reinforce plastic. In some embodiments the grille comprises carbon fibre.

In specific embodiments, the bars are plastic or metal or a combination of metal and plastic. The bars of the grille may comprise metal with a coating of plastic. The bars of the grille may comprise metal with a coating of infrared transmitting material. Aptly the grille has mechanical strength. Aptly the bars have mechanical strength. Aptly the grille, the bars, or both the grille and bars, provide mechanical strength to the lens, the lens structure or both.

In some embodiments the grille comprises a width from one side of the bars to the other, in the range of 0.2 millimetres to 3 millimetres. In some embodiments, the grille is in the range of 1 millimetre to 2.5 millimetres wide from one side of the bars to the other side of the bars. In specific embodiments, the grille is in the range of 1.3 millimetres to 2.1 millimetres wide from one side of the grille to the other side of the grille. In specific embodiments the grille is in the range of 1.3 millimetres to 2.06 millimetres wide, from one side of the bars to the other side of the bars. Thus, there is provided a grille which has a low weight, and which has a low cost of manufacture.

In some embodiments, the grille is 1.3 millimetres wide from one side of the bars to the other side of the bars. In specific embodiments the grille is 1.5 millimetres wide from one side of the bars to the other side of the bars. In specific embodiments the grille is 2.03 millimetres wide from one side of the grille to the other side of the grille.

In some embodiments the bars are the same width as the grille, from one side of the grille to the other side of the grille, in the upright normal use orientation of the grille. However, the width between the bars may be the same or different as the width of the grille. Ideally the greater area of space between the bars, or in other words the greater area of the apertures, or spacing, between the network of bars, the better vision through the grille. However, the greater area of apertures between the network of bars may mean less mechanical strength. Thus, there needs to be a balance of bars and the area of apertures of the grille. Other factors need to be considered in the balance of strength and vision as the mechanical strength of the bars also influences this balance. For example, a bar with high mechanical strength, for example, stainless steel, may allow thinner bars between the apertures of the grille.

In some embodiments the area of apertures of the grille is 60 to 85 percent of the total side area of the grille. Thus, with a side area of the grille comprising 80 percent apertures means only 20 percent of the side area of the grille is bars blocking the view. The advantage of having only one grille is that the two grilles do not need to be lined up or else the percentage of the viewing area will be decreased even further from the percentage of bars from one grille. In alternative embodiments the area of the apertures of the grille of the total side area of the grille may be in the range 70 to 80 percent. In specific embodiments, the area of the apertures of the grille of the total side area of the grille may be in the range of 75 to 90 percent.

The planar area of an aperture of the grille, on a side of the grille, in some embodiments may be in the range of 10 to 50 millimetres square in area. In specific embodiments the planar area of an apertures of the grille, on a side of the grille may be in the range of 25 to 35 millimetres square.

In specific embodiments the infrared transmitting material comprises a polymer. Alternatively, or additionally, the infrared transmitting material may comprise glass or crystalline. The advantage of an infrared transmitting material comprising polymer is that it has ease of manufacture and less cost. Also, polymer has the advantage that it is able to bend without breaking, more so than crystalline and glass. Using polymers as the infrared transmitting material of the present invention, advantageously are also able to withstand compression. Polymers suitable for use in the invention may, for example, comprise polyethylene, high molecular weight polyethylene (HMWPE), high density polyethylene, ultra-high molecular weight polyethylene (UHMWPE), polypropylene, sulphur-based polymers or polymethyl methacrylate, or any combination thereof. Infrared transmitting polymers by the trademark PolyIR, are also suitable infrared transmitting polymers, for use in the present invention.

Aptly the infrared transmitting material enables infrared radiation in the wavelength range of about 0.5 micrometres to about 1 millimetre to transmit through the infrared transmitting material and thus through the infrared transmitting lens. In specific embodiments the infrared transmitting material enables infrared radiation in the wavelength range of 0.4 micrometres to 15 micrometres to transmit through the infrared transmitting material and thus through the infrared transmitting lens. In specific embodiments the infrared transmitting material enables infrared radiation in the wavelength range of 0.5 micrometres to 14 micrometres to transmit through the infrared transmitting material and thus through the infrared transmitting lens. In specific embodiments the infrared transmitting material enables infrared radiation in the wavelength range of 0.5 micrometres to 3 micrometres to transmit through the infrared transmitting material and thus through the infrared transmitting lens. In specific embodiments the infrared transmitting material enables infrared radiation in the wavelength range of 3 micrometres to 5 micrometres to transmit through the infrared transmitting material and thus through the infrared transmitting lens. In specific embodiments the infrared transmitting material enables infrared radiation in the wavelength range of 8 micrometres to 14 micrometres to transmit through the infrared transmitting material and thus through the infrared transmitting lens.

In some preferred embodiments, the infrared transmitting material is in the range of 0.2 millimetres to 0.45 millimetres wide from one side to the other. By providing an infrared transmitting material in the range of 0.2 millimetres to 0.45 millimetres, the lens has a low weight, and a reduced cost of manufacture. Further, by having an infrared transmitting material that is thin, the transmissivity of the material is improved. These benefits can be provided without forfeiting structurally rigidity and strength, which is provided by the grille.

In some embodiments, the infrared transmitting material is in the range of 0.1 millimetres to 0.3 millimetres wide from one side to the other.

In specific embodiments, the infrared transmitting material is in the range of 0.15 millimetres to 0.25 millimetres wide from one side to the other.

In some embodiments, the infrared transmitting material in total width is 0.5 millimetres or less. For example, the infrared transmitting material on each side of the grille may be the same width, such that each side has a total width of 0.25 millimetres or less. In other embodiments, the infrared transmitting material on each side of the grille may have a different width, but the total width is 0.5 millimetres or less. For example, the infrared transmitting material on one side of the grille may be 0.2 millimetres or less, and the infrared transmitting material on the other side of the grille may be 0.3 millimetres or less.

In some embodiments, the infrared transmitting material in total width is 0.4 millimetres or less. For example, the infrared transmitting material on each side of the grille may be the same width, such that each side has a total width of 0.2 millimetres or less. In other embodiments, the infrared transmitting material on each side of the grille may have a different width, but the total width is 0.4 millimetres or less. For example, the infrared transmitting material on one side of the grille may be 0.1 millimetres or less, and the infrared transmitting material on the other side of the grille may be 0.3 millimetres or less.

In specific embodiments when two infrared transmitting materials are used these may be pushed together. When pushed together at least some areas of the infrared transmitting material may appear as one infrared transmitting material. Ideally when two infrared transmitting materials are together the total width is less than 0.5 millimetres.

In specific embodiments the infrared transmitting material may be attached to the grille by adhesive. The adhesive may, for example, be applied to a portion of the side, or sides, of the grille. On a side where adhesive has been applied, the infrared material may be positioned making contact with at least some adhesive, such that the infrared material is held in position. In specific embodiments adhesive applied to both sides of the grille and infrared material is positioned to both sides of the grille. The infrared material may be held in position on both sides of the grille by adhesive. Adhesive does not need to be applied to the complete side or sides of the grille. Ideally a sufficient amount of adhesive will be applied to a side or sides of the grille to enable holding of the infrared material in position.

In some embodiments the infrared transmitting material may be attached to the grille by adhesive-tape. In specific embodiments the infrared transmitting material may be attached to the grille by double-sided adhesive-tape. The adhesive-tape, or double-sided adhesive-tape may, for example, be applied to a portion of the side, or a portion of both sides, of the grille. Ideally when adhesive-tape, that only has adhesive on one side of the adhesive tape, is used, the adhesive-tape may be folded over such that adhesive can contact both the grille and the infrared material. Using adhesive tape, or double-sided adhesive-tape has the advantage that adhesive is less likely to run off the bars of the grille and block the gaps between the bars of the grille.

In embodiments where adhesive-tape or double-sided adhesive-tape has been applied to, a portion of one side, or a portion of both sides of the grille, the infrared material may be positioned making contact with at least some adhesive, such that the infrared material is held in position. In specific embodiments adhesive-tape, or double-sided adhesive-tape is applied to a portion of both sides of the grille and infrared material is positioned to both sides of the grille. The infrared material may be held in position on both sides of the grille by adhesive-tape, or double-sided adhesive-tape. Adhesive-tape, or double-sided adhesive-tape, does not need to be applied to the complete side or sides of the grille. Likewise the adhesive-tape, or double-sided adhesive-tape, need not be in contact with the entire side of the infrared transmitting material. Ideally a sufficient amount of adhesive-tape, or double-sided-adhesive tape, will be applied to a side or sides of the grille to enable holding of the infrared material in position. In specific embodiments when adhesive-tape, or double-side adhesive-tape is used to secure the infrared materials and grille together, the grille is between two infrared transmitting materials.

In some embodiments the corresponding array of apertures of the double-sided adhesive-tape is an exact, or almost exact match to the array of apertures of the grille. In other embodiments the corresponding array of apertures of the adhesive tape are not an exact match. Using a greater amount of double-sided adhesive-tape may give a greater hold. However, applying double-side adhesive-tape to the bars of the grille only and not partially covering any apertures may be difficult. Therefore in some embodiments double-sided adhesive-tape may be used only sufficiently in amount to hold the infrared transmitting material to the grille and that there is sufficient apertures, or part of the apertures, not blocked to enable infrared transmitting inspection through the grille. The double-sided adhesive-tape may, for example in some embodiments, be used only on the outer periphery of the grille in order not to block the array of apertures or at least not block a significant portion of the apertures.

Positioning of the adhesive-tape, or double-sided adhesive-tape, to a portion of the side of the grille may be assisted by using a jig that may accurately apply the adhesive-tape, or double-sided adhesive-tape, to the bars of the grille and not block or fill the apertures of the grille, between the bars of the grille, and thus still enable infrared transmission through the grille when adhesive-tape, or double-sided adhesive tape, is used to secure the infrared transmitting material in position. Advantageously using a jig may enable accurate positioning of the adhesive-tape, or double-sided adhesive-tape. A jig may be used to cut the required apertures in the adhesive tape, or double-sided adhesive-tape.

In specific embodiments the infrared transmitting lens is circular in shape. In other embodiments the infrared transmitting lens may have a different shape, for example, a square, a triangle, an ellipse, a rectangle, square or an oval.

By providing an infrared transmitting lens comprising a grille, wherein the grille comprises infrared transmitting between the network of bars of the grille, the infrared transmitting material has an improved integration with the protective grille. This increases the structural rigidity and strength of the infrared transmitting lens, enabling the manufacture of a thin lens still able to obtain high mechanical strength.

The present invention provides a method of manufacturing an infrared transmitting lens for mounting in an aperture of a housing containing an apparatus to be subjected to infrared inspection, comprising the steps of:
providing a grille, wherein the grille comprises a network of bars with an array of apertures between the network of bars;
providing an infrared transmitting material to a first side of the grille;
providing an infrared transmitting material to a second side of the grille.

Also, the present invention further provides a method of manufacturing an infrared transmitting lens for mounting in an aperture of a housing containing an apparatus to be subjected to infrared inspection, comprising the steps of:
providing a grille, wherein the grille comprises a network of bars with an array of apertures between the network of bars;
providing an infrared transmitting material to a first side of the grille; and
compressing the grille and infrared transmitting material together such that the infrared transmitting material, at least partially, fills the array of apertures between the network of bars of the grille.

In specific embodiments the method of manufacturing an infrared transmitting material further comprises the step of applying folded-over adhesive tape, or double-sided adhesive-tape, to a portion of the network of bars of the grille on both sides of the grille before positioning or providing infrared transmitting materials to both sides of the grille.

In some embodiments there is provided an infrared transmitting material that is adhered to the grille by compression. In some embodiments the infrared transmitting material adheres to the grille by compression. The compressive force applied aligns the infrared transmitting material with the array of apertures of the grille and may at least partially, fills the array of apertures with the infrared transmitting material. Infrared may pass through the infrared transmitting material and through the array of apertures during an infrared inspection.

In specific embodiments, the method of manufacturing an infrared transmitting lens further comprises the step of: providing a second infrared transmitting material to a second side of the grille. In further embodiments the method of manufacturing an infrared transmitting lens further comprises the step of compressing the second infrared transmitting material into the grille on the second side of the grille. Both sides of the grille may be provided with an infrared transmitting material. Advantageously, with infrared transmitting material on both sides of the grille allows protection to both sides of the grille, for example, from corrosion. Having an infrared transmitting material, for example, a polymer compressed from both sides of the grille may enable the space between the network of bars of the grille to be filled more evenly than if the infrared transmitting material was only compressed from one side. When the infrared transmitting material, for example, when comprising polymer, surrounds, or partially surrounds, the grille, the infrared transmitting material protects the grille from degradation, for example corrosion.

Also, the present invention provides a method of manufacturing an infrared transmitting lens for mounting in an aperture of a housing containing an apparatus to be subjected to infrared inspection, comprising the step of: extruding an infrared transmitting material around a grille to provide an infrared transmitting lens.

In specific embodiments, the method of manufacturing an infrared transmitting lens comprises the steps of:

As used herein, the term “aperture” is used to describe any slit, hole, slot, cavity, recess or opening. For example, an aperture may be a through-hole extending through a material from one side to the other. In other embodiments, the aperture may instead be a recess, or space, extending a depth into the surface on one side of a material. An aperture of the grille may be the area between the network of bars, which is not the bars of the grille, but which may be filled with another element, for example, a polymer.

As used herein, the term “array” is used to describe a structural arrangement. For example, an array of apertures is used to describe an arrangement of apertures of the grille. The term array includes, but not limited to, a plurality of apertures in a pattern.

As used herein, the term “double-sided adhesive-tape” is used to describe a tape that has adhesive on both sides of the tape.

As used herein, the term “grille” is used to describe a network of bars with apertures or spacing between the network of bars. The grille may often be generally planar but not limited to planar structures. The grille may be curved. The grille need not be flat. The term “faces of the grille” means the “sides of the grille” referring to the larger two sides of the grille. The outer peripheral portion being the edge of the grille.

As used herein, the term “infrared inspection” or “infrared imaging” is used to describe a condition monitoring process involving the detection of electromagnetic radiation in the infrared wavelength range.

As used herein, the term “infrared transmitting material” is used to describe a material that is capable of allowing infrared radiation to pass therethrough. The infrared transmitting material may be glass, crystalline material or a polymer, for example.

As used herein, the term “planar” is used to describe an element having a length that is substantially greater than its thickness. Generally having two sides or faces.

As used herein, the term “providing” includes the meaning of positioning.

As used herein, the term “bars” is used to describe the strands, of the grille, that is capable of providing structural strength or rigidity, or both strength and rigidity, to the grille. The bars may comprise any coating that is suitable for preventing corrosion, for example plastic. Typically, the bars comprise metal. The bars may be wire. The bars may be round across the width of the bar. The bars may be rod like in shape.

As used herein, the term “tessellation” is used to describe a patterned arrangement of features, typically but not limited to being on a surface of a material. For example, a tessellation maybe a repeat of a particular shape on a surface.

As used herein, the term “width” or “thickness” is used to describe the distance between two points, for example, two sides or faces. For example, the grille having a width of 0.5 millimetres indicates a distance of 0.5 millimetres between the two sides of the grille. The term width may also be used to describe the width, thickness or diameter of the bars, from one side of the grille to the other side of the grille.

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’ and ‘outer’, ‘outwardly’ refer to directions toward and away from, respectively, a designated centreline or a geometric centre of an element being described (e.g. central axis), the particular meaning being readily apparent from the context of the description.

Further, as used herein, the terms ‘connected’, ‘attached’, ‘coupled’, ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second”, “third” etc. merely indicate that different instances of like objects are being referred to and are not intended to imply that the objects so described must be in a given sequence, either temporally, spatially, in ranking or in any other manner.

### EXAMPLES

### Ex1

An infrared transmitting lens for mounting in an aperture of a housing containing an apparatus to be subjected to an infrared inspection, the infrared transmitting lens comprising:
a grille, the grille comprising a network of bars with an array of apertures between the bars, the grille providing mechanical protection to the infrared transmitting lens;
infrared transmitting material, positioned on both sides of the grille.

### Ex2

An infrared transmitting lens according to example Ex1, wherein the grille further comprises infrared transmitting material between the network of bars of the grille, such that the infrared transmitting material, at least partially, fills the array of apertures between the network of bars of the grille.

### Ex3

An infrared transmitting lens for mounting in an aperture of a housing containing an apparatus to be subjected to an infrared inspection, the infrared transmitting lens comprising: a grille, the grille comprising a network of bars with an array of apertures between the bars, the grille further comprising infrared transmitting material between the bars of the grille, such that the infrared transmitting material, at least partially fills, the array of apertures between the bars of the grille.

### Ex4

An infrared transmitting lens according to example Ex3, wherein further comprises, infrared transmitting material on one side of the grille.

### Ex5

An infrared transmitting lens according to anyone of examples Ex1, Ex2 or Ex3, wherein the array of apertures of the grille are equal in size and shape, and arranged in a regular array.

### Ex6

An infrared transmitting lens according to anyone of example Ex1 to Ex5, wherein the apertures of the grille are square, or circular; or rectangular; or triangular; or polygonal; or hexagonal; or any combination of square, circular, rectangular, triangular, polygonal or hexagonal.

### Ex7

An infrared transmitting lens according to anyone of examples Ex1 to Ex6, wherein the array of apertures of the grille are arranged in a tessellation.

### Ex8

An infrared transmitting lens according to anyone of examples Ex1 to Ex7, wherein the infrared transmitting lens is planar.

### Ex9

An infrared transmitting lens according to anyone of examples Ex1 to Ex8, wherein the infrared transmitting material comprises a polymer.

### Ex10

An infrared transmitting lens according to anyone of examples Ex1 to Ex9 wherein the grille comprises: plastic, or metal, or a combination of metal and plastic.

### Ex11

An infrared transmitting lens according to anyone of examples Ex1 to Ex10, wherein the grille is in the range of 0.2 millimetres to 3 millimetres wide from one side of the grille to the other side of the grille at a portion of the network of bars.

### Ex12

An infrared transmitting lens according to anyone of examples Ex1 to Ex11, wherein the infrared transmitting material, is in the range of 0.15 millimetres to 0.45 millimetres wide, in total, from one side to the other.

### Ex13

An infrared transmitting lens according to anyone of examples Ex1 to Ex12, wherein the infrared transmitting material in total width is 0.4 millimetres.

### Ex14

An infrared transmitting lens according to anyone of examples Ex1 to Ex13, wherein the infrared transmitting material is nonplanar.

### Ex15

An infrared transmitting lens according to anyone of examples Ex1 to Ex14, wherein the infrared transmitting material forms a seal across the infrared transmitting lens, or the grille, such that the seal is impermeable to fluids.

### Ex16

An infrared transmitting lens according to anyone of wherein the infrared transmitting material comprises protrusions.

### Ex17

An infrared transmitting lens according to example Ex1, wherein further comprises double-sided adhesive-tape on, a portion, of both sides of the grille, the double-sided adhesive-tape is between the grille and the infrared transmitting material.

### Ex18

A method of manufacturing an infrared transmitting lens for mounting in an aperture of a housing containing an apparatus to be subjected to infrared inspection, comprising the steps of:
providing a grille, wherein the grille comprises a network of bars with an array of apertures between the network of bars;
providing an infrared transmitting material to a first side of the grille; and
compressing the grille and infrared transmitting material together such that at least a portion of the infrared transmitting material is positioned in the array of apertures between the network of bars of the grille.

### Ex19

A method of manufacturing an infrared transmitting lens according to example Ex18, wherein the method further comprises the step of: providing a second infrared transmitting material to a second side of the grille, before the compressing step.

### Ex20

A method of manufacturing an infrared transmitting lens for mounting in an aperture of a housing containing an apparatus to be subjected to infrared inspection, comprising the step of:
providing a grille, wherein the grille comprises a network of bars with an array of apertures between the network of bars; and,
extruding an infrared transmitting material to the grille, such that at least a portion of the extruded infrared transmitting material is positioned between the network of bars of the grille.

### Ex21

A method of manufacturing an infrared transmitting lens for mounting in an aperture of a housing containing an apparatus to be subjected to infrared inspection, comprising the steps of:
providing a grille, wherein the grille comprises a network of bars with an array of apertures between the network of bars;
providing an infrared transmitting material to a first side of the grille; and,
providing an infrared transmitting material to a second side of the grille.

### Ex 22

A method of manufacturing an infrared transmitting lens according to example Ex21, further comprising the step of: applying double-sided adhesive-tape to, a portion of the bars of the grille, on both sides of the grille, before; providing an infrared transmitting material to a first side of the grille and providing an infrared transmitting material to a second side of the grille.

Embodiments of the invention are further described hereinafter with reference to the accompanying drawings, in which:

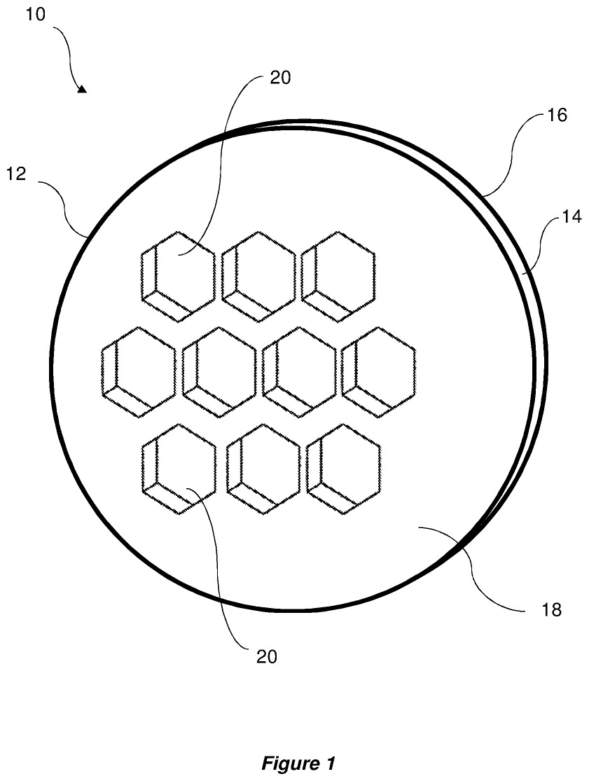

FIG. 1 is a perspective view of a grille suitable for use in the present invention;

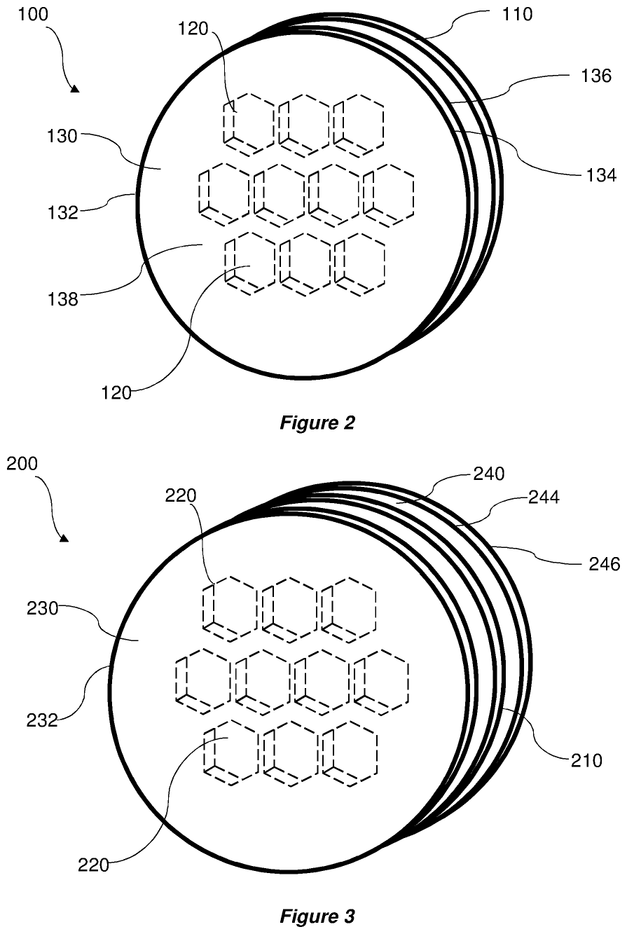

FIG. 2 is a perspective view of an infrared transmitting material suitable for use in the present invention;

FIG. 3 is a perspective view of an infrared transmitting lens according to an embodiment of the invention;

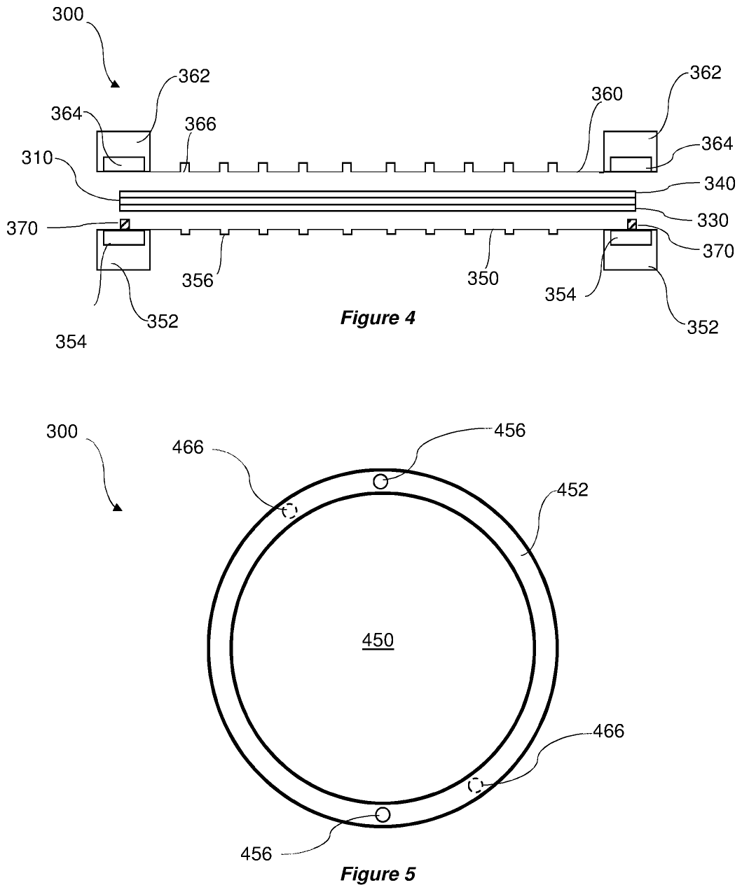

FIG. 4 is a schematic view of an infrared lens of the invention;

FIG. 5 is a front view of the infrared lens assembly in FIG. 4;

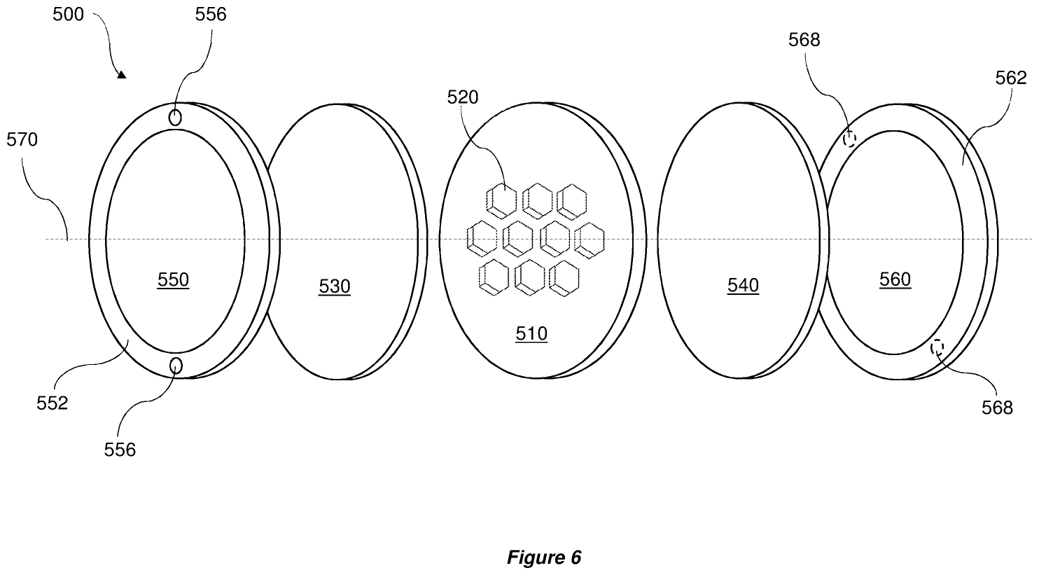

FIG. 6 illustrates an exploded view of an infrared lens assembly;

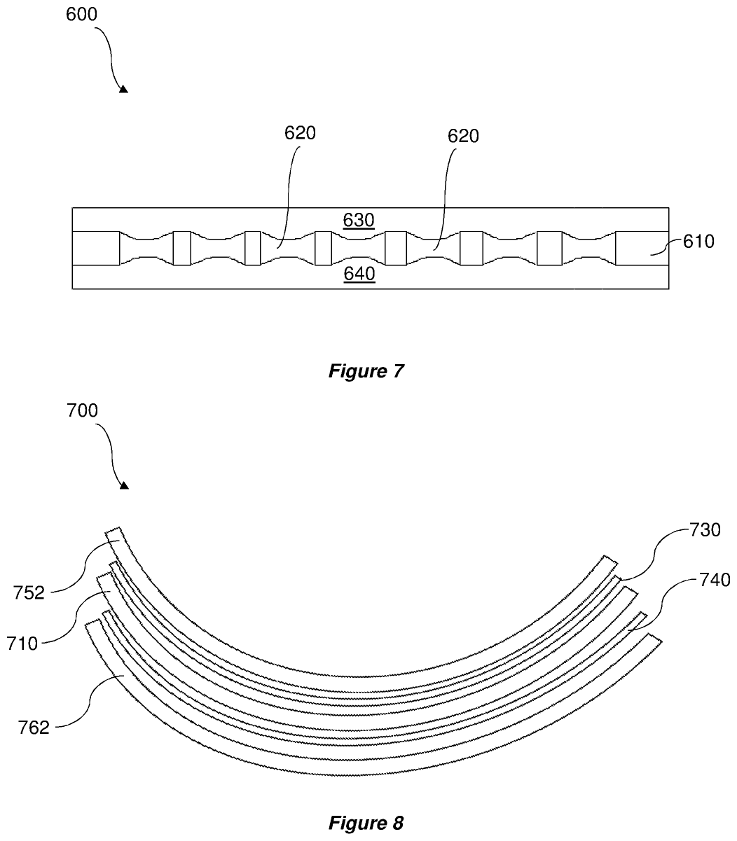

FIG. 7 is a schematic section view of an infrared lens according to an embodiment of the invention;

FIG. 8 is a schematic section view of an infrared lens according to another embodiment;

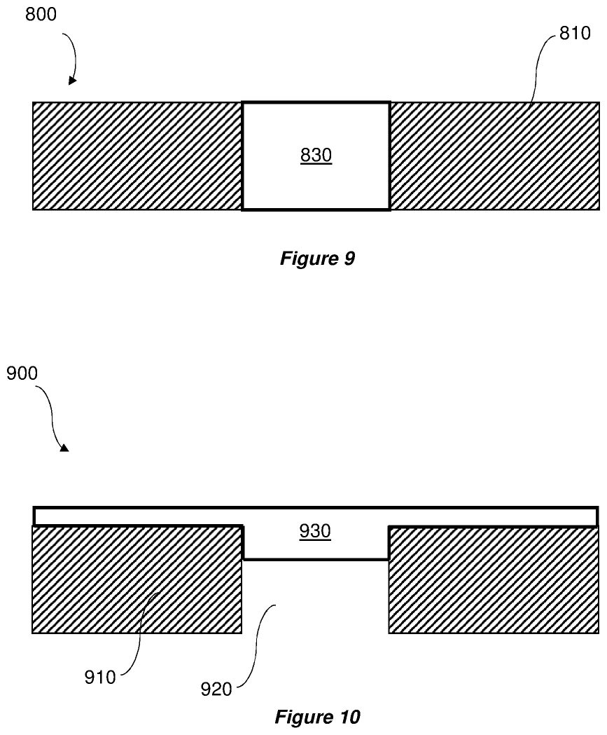

FIG. 9 shows a schematic view of an infrared transmitting lens according to an embodiment;

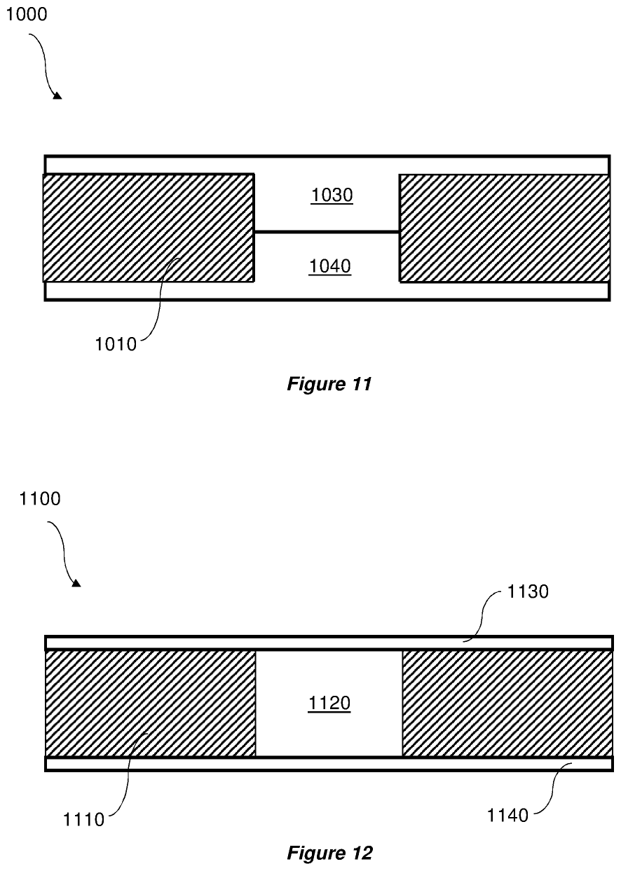

FIG. 10 shows a schematic view of an infrared transmitting lens according to another embodiment;

FIG. 11 shows a schematic view of an infrared transmitting lens according to a further embodiment; and

FIG. 12 shows a schematic view of an infrared transmitting lens according to a yet further embodiment.

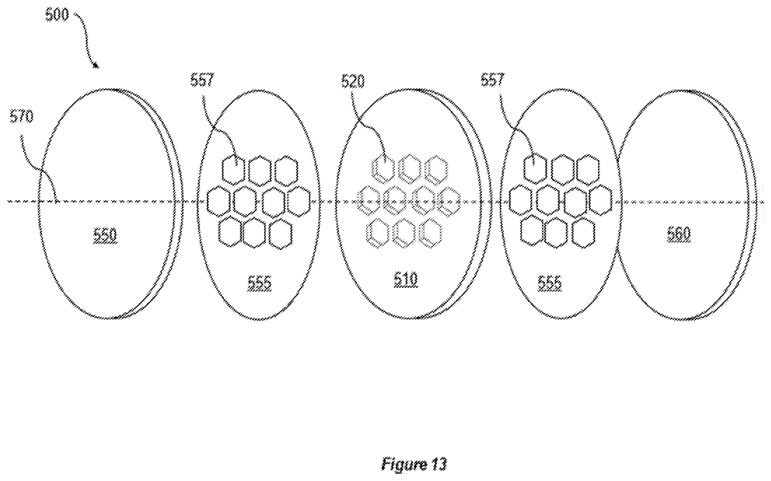

FIG. 13 shows an exploded view of an infrared transmitting lens according to a further embodiment.

Like reference numerals are used to depict like features throughout.

FIG. 1 shows a grille 10. The grille 10 is generally planar and has a front side 12 and a rear side 16. The grille 10 also has a peripheral edge portion 14 defined between the front side 12 and the rear side 16. The grille 10 has a substantially circular shape in this embodiment. But in other embodiments, the grille 10 may take the form of another shape, such as, for example, a square, a rectangle, an ellipse or an oval. The grille 10 comprises a network of bars 18. In this particular embodiment, the grille 10 comprises aluminium, but it should be appreciated that the grille 10 may instead comprise different materials such as, for example, stainless steel, titanium, copper, plastic, a metal coated with plastic, or a plastic coated with a metal. The network of bars 18, which in this case is aluminium, has an array of apertures 20. The apertures 20 in this embodiment have a hexagonal shape extending through both the front side 12 and the rear side 16. That is, the apertures 20 extend through the thickness of the grille 10. The apertures 20 have a regular hexagonal shape. In this embodiment the edges of the hexagon have an equal length. In other embodiments however, the apertures 20 may have other shapes, for example but not limited to, a circular shape, a rectangular shape, a square shape, a triangular shape, a polygonal shape, or any combination of these shapes. It should further be appreciated that the array of apertures 20 may be arranged in a tessellation, and that the array of apertures 20 may extend to cover a larger area of the grille 10, or may extend across a smaller area of the grille 10. For example, the array of apertures 20 may extend to cover almost the entirety of the grille 10, or substantially the entirety of the grille 10. That is, the array of apertures 20 may extend towards and meet the outer periphery of the grille 10.

FIG. 2 illustrates an infrared transmitting lens 100. In this embodiment the infrared transmitting lens has an infrared transmitting material 130 on one side of a grille 110. In the FIG. 2 the infrared transmitting material 130 is largely blocking a view of the grille 110. For convenience the apertures 120 of the grille 110 are shown by dashed lines. The infrared transmitting lens 100 comprises a grille 110 and an infrared transmitting material 130. The grille 110 is substantially the same as the grille 10 in FIG. 1 and therefore will not be described again in detail. In this embodiment the infrared transmitting material 130 is on the front side 112 of the grille 110 and lies parallel and flush against it. The infrared transmitting material 130 in this embodiment is at least partially compressed into the grille 110. In this embodiment, the infrared transmitting material 130 comprises a polymer 138. An infrared transmitting material 130 comprises polymer 138 is particularly preferred because it has a relatively lost cost. Additionally, polymer material is easy to mould, compress and/or deform, which is beneficial, as will be discussed. Particularly in this embodiment, the infrared transmitting material 130 comprises polyethylene. However, in other embodiments other polymers may be used, for example, high molecular weight polyethylene (HMWPE), high density polyethylene, ultra-high molecular weight polyethylene (UHMWPE), polypropylene, sulphur-based polymers or polymethyl methacrylate. In this FIG. 2 embodiment the infrared transmitting material is positioned on one side of the grille and at least partially within the apertures of the grille.

In this embodiment, the infrared transmitting material 130 is relatively thin in width. More specifically, the infrared transmitting material 130 in this embodiment has a width of 0.2 millimetres. This is particularly important since the infrared transmitting material 130 is to enable transmitted infrared radiation to pass through the infrared transmitting material 130. The infrared transmitting material 130 enables infrared radiation in the wavelength range of about 0.5 micrometres to about 14 um to pass through. In specific embodiments the infrared the infrared transmitting material 130 has a front side 132 and a rear side 136, and a peripheral edge portion 134 defined in between the front side 132 and the rear side 136. When infrared radiation (not shown) passes through the hexagonal apertures 120 of the grille, the infrared radiation extends towards and transmits through the infrared transmitting material 130. In other embodiments the infrared transmitting material 130 may comprise a different material, and the infrared transmitting material 130 may have a different width from the front side 132 to the rear side 136 of the infrared transmitting material 130 so long as its width and the properties of the infrared transmitting material 130 allow infrared radiation to pass therethrough. In some embodiments, the infrared transmitting material 130 comprises protrusions (not shown) that correspond to the hexagonal apertures 120 of the grille 110 such that infrared can transmit through the hexagonal apertures 120 and through the protrusions of the infrared transmitting material 130.

FIG. 3 illustrates an embodiment of an infrared transmitting lens 200. The infrared transmitting lens 200 comprises a grille 210 and a first infrared transmitting material 230. The grille 210 is substantially the same as the grille 10 in FIG. 1 and thus will not be described again in detail. Likewise, the first infrared transmitting material 230 is substantially the same as the infrared transmitting material 130 in FIG. 2 and thus will not be described again in detail. The infrared transmitting lens 200 further comprises a second infrared transmitting material 240 on the rear side (not shown) of the grille 210 and lies parallel and flush against the grille.

In the FIG. 3 embodiment, the second infrared transmitting material 240 comprises a polymer. In other embodiments, the second infrared transmitting material 240 may comprise glass or crystalline, for example. The advantage that both infrared transmitting materials 230, 240 are polymer or comprise polymer, include ease of manufacture and lower costs. Suitable polymers include, but not limited to, for example, high molecular weight polyethylene (HMWPE), high density polyethylene, ultra-high molecular weight polyethylene (UHMWPE), polypropylene, sulphur-based polymers or polymethyl methacrylate. In this particular embodiment, both the first infrared transmitting material 230 and the second infrared transmitting material 240 are comprises polypropylene, however it should be appreciated that the materials of the first infrared transmitting material 230 and the second infrared transmitting material 240 may be different polymers, and in other examples, the first infrared transmitting material 230 and the second infrared transmitting material 240 may be different materials altogether, such as, for example, a polymer and a glass.

In this embodiment, the second infrared transmitting material 230 also has a relatively thin width. More specifically, the second infrared transmitting material 240 in this embodiment has a width, or thickness, of 0.2 millimetres. Likewise, the first infrared transmitting material 230 also has a width, or thickness, of 0.2 millimetres. Thus, the overall total width of the first infrared transmitting material 230 combined with the second infrared transmitting material 240 has a width of 0.4 millimetres. The grille 210 in this embodiment has a width, from front side of the grille (not shown) to the rear side, of 0.5 millimetres. The material of the first 230 and second 240 infrared transmitting materials and the width of same, allow infrared radiation to pass therethrough. That is, when infrared radiation (not shown) passes through either one of the first 230 and second 240 infrared transmitting materials, the infrared radiation passes through the hexagonal apertures 220 (for convenience shown as dashed lines) of the grille 210 and extends towards and transmits through the other one of the first 230 and second 240 infrared transmitting materials. In some embodiments each of the infrared transmitting materials 230, 240 may comprise a number of different materials, and each of the infrared transmitting materials 230, 240 may have a different width, so long as its width and the properties of the infrared transmitting material 230, 240 allow infrared radiation to pass therethrough.

When the infrared transmitting lens 200 is assembled together, the first infrared transmitting material 230 and the second infrared transmitting material 240 are compressed inwards towards the grille 210, in this embodiment. In some alternative embodiments the first and second infrared transmitting materials are not compressed. In this embodiment a compressive force is applied onto the front side 232, of the first infrared transmitting material 230 in a direction towards the grille 210. A compressive force is also applied on the rear side 246 of the second infrared transmitting material 240 compressing towards the grille 210. The first infrared transmitting material 230 in this embodiment is a polymer. When a compressive force is applied onto the front side 232 of the first infrared transmitting material 230, a portion of the first infrared transmitting material 230 is positioned between the network of bars. Thus, in this embodiment the grille comprises infrared transmitting material between the bars of the grille. In this specific FIG. 3 embodiment there is an air gap in the apertures, after compressing the first and second infrared transmitting material together. In this specific FIG. 3 embodiment the infrared transmitting material at least partially fills the apertures of the grille. In some alternative embodiments, the first transmitting material 230 deforms and fills the array of apertures 220. Likewise, in some embodiments, when a compressive force is applied onto the rear side 246 of the second infrared transmitting material 240, a portion of the second infrared transmitting material 240 is positioned between the network of bars. In some embodiments, the second transmitting material 240 deforms and fills the array of apertures 220. In some embodiments it is the infrared transmitting material from either one side or both sides that may at least partially fill the apertures. In embodiments when the apertures of the grilles are partially filled there may be an air gap. In embodiments where the apertures of the grille are filled there may be little to no air gap. The filling of the array of apertures in this way will be described in more detail later with reference to FIG. 7.

The present invention covers embodiments where the grille has infrared transmitting material positioned on both sides of the grille. This embodiment may look similar to that of FIG. 3 shown. In some embodiments where there is infrared transmitting material on both sides of the grille, there need not be necessarily any compression of the infrared transmitting material. In embodiments where there is no compression the infrared material may comprise, for example, polymer, crystalline or glass or any combination thereof. In embodiments where the infrared transmitting material is positioned to a side of the grille the infrared transmitting material may comprise, for example, polymer, crystalline or glass, or any combination thereof.

By combining different materials for the infrared transmitting materials used may lead to many different final compositions of the infrared transmitting lens. For example, an infrared transmitting material comprising crystalline may be used on one side of the grille and an infrared transmitting material comprising polymer on the other side of the lens. In this embodiment the apertures of the grille may comprise air. In this specific embodiment with different transmitting material on different sides of the grille may optionally further comprise a compression step such that the infrared transmitting material comprising polymer may be also positioned between the bars on the grille, at least partially filling the apertures of the grille.

FIG. 4 shows, an infrared transmitting lens, of the present invention, optionally within a window assembly 300. The embodiment shown in FIG. 4 is not to be construed as requiring the optional window frame, covers and other window assembly components, these are included for illustrative purposes only. The infrared transmitting lens comprises a grille 310 and infrared transmitting material 330, 340 positioned on both sides of the grille 310, a first infrared transmitting material 330 positioned on one side of the grille 310 and a second infrared transmitting material 340 positioned on the other side of the grille 310. Thus, this embodiment comprises a grille 310 wherein the grille 310 further comprises infrared transmitting material on two sides of the grille 310. The infrared transmitting lens, in this embodiment, is a composition of parts. The arrangement of the grille 310, first infrared transmitting material 330 and second infrared transmitting material 340 is substantially the same as the infrared transmitting lens 200 in FIG. 3 so will not be described here again in detail. The infrared transmitting lens 300 of the FIG. 4 embodiment is however shown after compression. The FIG. 4 embodiment of an infrared transmitting lens 300 is illustrated after the first 330 and second 340 infrared transmitting materials are compressed together by hand towards the grille 310. In alternative embodiments the compression may be by a machine. The compression used to compress the first 330 and second 340 infrared transmitting material, in this embodiment, is in the range of 5 to 38 Newtons. The infrared transmitting lens 300 in this embodiment is shown, for illustrative purposes, optionally with a window comprising a rim 352, 362, and also optionally an attachment mechanism 364, 370. As the first 330 and second 340 infrared transmitting material is compressed a portion of the infrared transmitting material enters the array of apertures of the grille 310 and therefore at least a portion of the infrared transmitting material is positioned between network of bars of the grille 310. Thus, in this embodiment the grille 310 comprising bars, further comprises infrared transmitting material between the bars of the grille 310. The polymer (in this embodiment) of the first 330 and second 340 infrared transmitting materials coats the outer surfaces of the grille 310, on both sides of the grille 310 in the network of bars of the grille 310. At the aperture portion of the grille 310 where the first and second infrared transmitting material are compressed together a portion of the first and second infrared transmitting material is at least partially positioned between the network of bars of the grille 310. In this embodiment the infrared transmitting lens is shown optionally sitting in a window frame that comprises removable protective screens 350, 360, with protrusions 356, 366. The infrared transmitting lens is held in the window frame or ridge 362 and 352 by attachment mechanisms 364, 370. In specific embodiments the removable screens 350, 360 would be normally positioned over the infrared transmitting lens but when inspection is required both protective screens 350, 360 would be temporarily removed, for example, by sliding these out of view of the infrared transmitting lens. Ideally both protective screens 250, 360 are slid out of view, by a mechanism or operation from the outer side of the window thus the container does not have to be opened to remove the protective screens 350, 360. The grille in this embodiment is 0.4 millimetres in width. Both the first and second infrared transmitting materials are 0.2 millimetres in width before compression. However, after compression, as a portion of the first 330 and second 340 infrared transferring material is positioned between the network of bars of the grille 310, the width of the combined first 330 and second 340 infrared transmitting material is 0.4 millimetres in width. millimetres. Thus, even though the total width of the infrared transmitting material is required to be relatively thin, preferably less than 0.45 millimetres, this arrangement of the FIG. 4 embodiment enables a grille of a larger width (than the total width of the infrared transmitting material) to be used. Advantageously a wider and stronger grille can be used to give mechanical strength or protection, that still enables a relatively thin (preferably less than 0.45 millimetres) width of infrared transmitting material to be used.

FIG. 5 shows a plan view of the infrared transmitting lens of the FIG. 4 embodiment in use, also showing the optional window rim 452 and optional attachment points 466, 456 for the optional protective screens 350, 360.

FIG. 6 illustrates an exploded assembly view of window assembly 500 comprising an infrared transmitting lens, also shown in exploded view. The infrared transmitting lens comprises a grille 510 and infrared transmitting material 530, 540 on both sides of the grille. FIG. 6 also shows the optional components that make up the window assembly 500, the window assembly 500 having a central axis 570. The FIG. 6 embodiment window assembly shows optional front and back protective screens 550, 560. Each component is generally planar in shape, having a front side and a rear side. Each component in this embodiment is also substantially circular in shape. The window assembly 500 shows an infrared transmitting lens comprising a grille 510 positioned centrally in the infrared transmitting lens. The grille 510 is formed from a network of bars. In this embodiment, the grille 510 is formed from aluminium. The network of bars (aluminium), has an array of apertures 520. In this embodiment the apertures 520 have a hexagonal planar shape. The apertures 520 extend through the width of the grille 510. It should be appreciated that the array of apertures 520 may extend to cover a larger side surface area of the grille 510, or may extend to cover a smaller side surface area of the grille 510. For example, the array of apertures 520 may extend to cover substantially the entirety of the grille 510. That is, the array of apertures 520 may extend towards and meet the outer periphery of the grille 510.

On either side of the grille 510, there is provided infrared transmitting material 530, 540. Specifically, in this embodiment, a first infrared transmitting material 530 made of a polymer is positioned on a front side of the grille 510. A second infrared transmitting material 540 also made of a polymer is positioned on a rear side of the grille 510. In this embodiment the grille 510 comprises infrared transmitting material on two sides of the grille 510. The infrared transmitting material 530, 540 on either side of the grille 510 lies parallel and flush against the grille 510. The material of the first 530 and second 540 infrared transmitting materials and the width of same, allow infrared radiation to pass therethrough. When infrared radiation (not shown) passes through either one of the first 530 and second 540 infrared transmitting materials, the infrared radiation passes through he hexagonal apertures 520 of the grille 510 and extends towards and transmits through the other one of the first 530 and second 540 infrared transmitting materials.

In this embodiment, the infrared transmitting materials 530, 540 have a width from one side to the other, of 0.2 millimetres, and they comprise a polymer. However, it should be appreciated that each of the infrared transmitting materials 530, 540 may comprise a different material, and each of the infrared transmitting materials 530, 540 may have a different width, so long as its width and the properties of the infrared transmitting material 530, 540 allow infrared radiation to pass therethrough.

For illustrative purposes of showing the lens of the present invention in use, optional covers, and rim and other optional window components are shown. A first movable optional cover 550 is provided on a front side, positioned near to the first infrared transmitting material 530. The first removable optional cover 550 has a rim 552 positioned around the periphery of the first movable optional cover 550. The rim 552 is provided with attachment points 556.

Similarly, a second optional cover 560 is provided at the rear side, positioned near the second infrared transmitting material 540. The second optional cover 560 also has a rim 562 positioned around the periphery of the second cover 560. The rim 562 also has attachment points 568. In this embodiment the optional attachment points 568, 556 assists to hold the optional cover in place when viewing is not required but enable easy removal of the optional covers from any one side when viewing through the infrared transmitting lens is required.

In use, the infrared transmitting lens 530, 510, 540 can be mounted in an aperture of a housing containing an apparatus to be subjected to infrared inspection. The window assembly 500 can be mounted within a housing. Thus, infrared radiation can be transmitted through the apertures 520 of the grille 510 and through the infrared transmitting materials 530, 540 to inspect inside the housing. In this embodiment, the infrared transmitting lens comprising the grille 510 and the first 530 and second 540 transmitting materials can be assembled together by compressing the first infrared transmitting material 530 and the second infrared transmitting material 540 inwards towards the grille 510. In some embodiments, when a compressive force is applied on the first infrared transmitting material 530, the first infrared transmitting material 530 deforms and fills the array of apertures 520 of the grille 510. This is better shown in FIG. 7.

FIG. 7 shows an embodiment comprising an infrared transmitting lens 600 comprising a grille 610, a first infrared transmitting material 630 on one side of the grille 610 and a second infrared transmitting material 640 on the other side of the grille 610. Thus, this embodiment comprises a grille 610 further comprising infrared transmitting material 630, 640 on both sides of the grille 610. The grille 610 comprises an array of apertures 620. In this embodiment, the grille comprises steel. In this embodiment the first infrared transmitting material 630 and the second infrared transmitting material 640 both comprise a polymeric material. More specifically, the first infrared transmitting material 630 and the second infrared transmitting material 640 comprise polyethylene. When a compressive force is applied on the outside of the first infrared transmitting material 630 towards the grille 610, the first infrared transmitting material 630 deforms and fills the array of apertures 620 from the front side. Likewise, when a compressive force is applied on the outside of the second infrared transmitting material 640 towards the grille 610, the second infrared transmitting material 640 deforms and fills the array of apertures 620 from the rear side. Thus, the apertures 620 are at least partially filled with the deformed polymer infrared transmitting materials 630,640. The embodiment shown in FIG. 7 is shown already compressed towards both sides of the grille. The apertures 620 are at least partially filled with polymer of the infrared transmitting materials 630 and 640. In this embodiment the infrared transmitting materials 630, 640 cover the grille 610 giving protection to the steel grille from corrosion. Infrared radiation is able to pass through the infrared transmitting materials 630, 640 and through the apertures 620 of the grille 610. In this embodiment the width of the grille 610 is 0.2 millimetres. In this embodiment the width of both the first 630 and second 640, infrared transmitting materials, after compression are 0.2 millimetres each. The total width of the infrared transmitting lens 600 of the FIG. 7 embodiment is 0.4 millimetres. In some embodiments, the apertures 620 are completely filled with infrared transmitting material 630, 640 from one or both sides of the grille 610, from the first infrared transmitting material 630 or the second infrared transmitting material 640, or both the first transmitting material 630 and second infrared transmitting material 640. Aptly the infrared transmitting material 630 and 640 form a seal. In some embodiments the infrared transmitting material 630, 640 form a seal that is fluid tight. Thus, in embodiments with a fluid tight seal, fluids, gas and liquids, cannot pass through the infrared transmitting lens. In other embodiments the infrared transmitting material may form a liquid tight seal and thus gas could pass through.

For illustrative purposes only, embodiments of the invention including those of FIGS. 4, 5, 6, 7 and 8 are shown and explained by embodiments of a lens of the present invention in use with optional window frame and optional covers and optional other window components. Window frame components and covers are optional and not to be limitations to these or other embodiments of the invention.

In the FIG. 8 embodiment, as illustrated in FIG. 8, the infrared transmitting lens (the combined, grille 710, first infrared transmitting material 730, and the second infrared transmitting material 740) may be curved. Window assembly 700 comprises an infrared transmitting lens comprising a grille 710, and first and second infrared transmitting materials 730, 740. The window assembly 700 of this FIG. 8 embodiment also shows optional, first and second covers 752, 762. The optional covers 752 and 762 are also curved. In this embodiment, the grille 710 has a curved profile, as does the first infrared transmitting material 730 and second infrared transmitting material 740. The first 730 and second 740 infrared transmitting materials have substantially the same curvature as the grille 710 so as to engagingly contact with the grille 710. Advantageously by having the infrared transmitting material 730, 740 with the same curvature as the grille 710 aids even distribution of the infrared transmitting material 730, 740 into the aperture of the grille 710 or over the grille 710. As previously described, the first infrared transmitting material 730 or the second transmitting material 740, or both the first 730 and second 740 infrared transmitting material, in some embodiments, may deform and at least partially fill the array of apertures (not shown) in the grille 710. The window assembly 700 is further provided with an optional curved first cover 752 and an optional curved second cover 762. Again, the first optional cover 752 and second optional cover 762 have substantially the same curvature as the grille 710, and as the first and second transmitting materials 730, 740. This arrangement is particularly advantageous as the curved infrared transmitting lens may be exposed to more potential damage. The curvature of the components within the infrared transmitting lens or window assembly 700 can be modified to correspond to the required curvature wanted for the infrared transmitting lens. Advantageously, in this embodiment, both infrared transmitting materials 730 and 740 comprise a polymeric infrared transmitting material, to allow the curved construction. The grille comprises a metal, in this embodiment.

FIG. 9 shows a part cross cut section of an infrared transmitting lens 800 according to an embodiment of the present invention. The infrared transmitting lens 800 comprises a grille 810 formed from a network of bars. The grille 810 comprises a network of bars. In this particular embodiment, grille 810 and the network of bars of the grille 810 comprises stainless steel. The network of bars of the grille has an array of apertures, however for simplicity, only one aperture is shown. The aperture is filled with an infrared transmitting material 830. In this embodiment, the infrared transmitting material is a polymeric material. More specifically, the infrared transmitting material comprises polyethylene. When infrared radiation (not shown) is directed towards the aperture of the grille 810, and the infrared transmitting material 830 therein, the infrared radiation transmits through the aperture and the infrared transmitting material 830. The Infrared transmitting material 830 enables infrared radiation in the wavelength range of about 0.5 micrometres to about 1 millimetre to transmit through the infrared transmitting material 830 and thus through the infrared transmitting lens 800. In this particular embodiment, the infrared transmitting material 830 has a width, from one side to the other side, of 0.4 millimetres. This is the same in this particular embodiment as the width of the grille at 0.4 millimetres. In other embodiments the infrared transmitting material 830 may have a different width, so long as its width and the properties of the infrared transmitting material 830 allow infrared radiation to pass therethrough. In this FIG. 9 embodiment there is no infrared transmitting material 830 on the outer surface of the sides of the grille 810 at the network of bars portion of the grille. Advantageously the grille is made of stainless steel and therefore is resistant to corrosion. The infrared transmitting lens of the FIG. 9 embodiment may be produced by extruding infrared transmitting polymer 830 into the apertures of the grille 810.

FIG. 10 shows an infrared transmitting lens 900 according to another embodiment. The infrared transmitting lens 900 comprises a grille 910 that is substantially the same as the grille 810 in FIG. 8, so will not be described again in detail. In this particular embodiment, the infrared transmitting lens comprises an infrared transmitting material 930 on a front side of the grille 910 positioned parallel and flush against the grille 910. The infrared transmitting material 930 comprises polymer, in this embodiment. To produce the FIG. 10 embodiment a sheet of infrared transmitting polymer 930 is placed, or positioned, on one side of the grille 910, and compressed into the grille by hand. A force of compression of approximately twenty newtons is used to compress the sheet of infrared transmitting material into the grille 910. In some alternative embodiments the compressing process of the infrared transmitting material may be a mechanical process. The infrared transmitting material 930 deforms and partially fills the aperture 920 of the grille 910. The apertures are filled sufficiently enough to offer protection, and prevent movement of objects through the infrared transmitting lens. In this FIG. 10 embodiment the sheet of infrared transmitting material is 0.2 millimetres in width before compression. After compression the sheet of infrared transmitting material is has a width of 0.4 millimetres in the apertures 920 portions of the grille and a width of 0.1 millimetres at the network of bars portion of the grille 910. The grille is 0.5 millimetres in width from one side to the other side, at the network of bars portion of the grille. Infrared radiation is able to travel through the grille at the aperture portions of the grille 910, through the infrared transmitting material 930. In this embodiment the infrared transmitting material 930 forms a fluid seal, preventing fluid from passing though the grille 910. The polymeric infrared transmitting material 930 also protects the grille from degradation for example from corrosion, or harmful chemicals.

In a further embodiment similar to that shown in FIG. 10, another infrared transmitting material, comprising polymer, similar to the first infrared transmitting material 930 could be positioned on the other side of the grille 910 and compressed together to give infrared transmitting material on both sides of the grille 910. The second infrared transmitting material (not shown) would be a mirror image of the infrared transmitting material 930 shown in the FIG. 10. Ideally the two infrared transmitting materials would join in the apertures of the grille 910. Again, the infrared transmitting materials form a fluid seal across the grille 910.

FIG. 11 shows an infrared transmitting lens 1000 according to a further embodiment. The infrared transmitting lens 1000 comprises a grille 1010 that is substantially the same as the grille 810 in FIG. 8 and grille 910 in FIG. 9, so will not be described again here in detail. The infrared transmitting lens 1000 further comprises a first infrared transmitting material 1030 positioned parallel and flush against a front side of the grille 1010 and a second infrared transmitting material 1040 positioned parallel and flush against a rear side of the grille 1010. The FIG. 11 embodiment is manufactured by placing, or positioning, two identical infrared transmitting sheets 1030, 140 comprising polymer on either side of a grille 1010 and compressing the two sheets of infrared transmitting material together into the grille 1010. The two infrared transmitting materials 1030 and 1040 both comprise polymer. The two infrared transmitting materials 1030 and 1040 are both manufacture as largely planar sheets with protrusions. The protrusions of the sheets of infrared transmitting materials are configured to correspond to the configuration, shape and positioning of the apertures in the grille 1010, such that the protrusions of the infrared transmitting materials 1030 and 1040 fit into the corresponding apertures of the grille. Further, in this embodiment the infrared transmitting materials 1030 and 1040 may abut, for example, flat, against a side, or opposites sides of the grille, with the protrusions within the apertures of the grille 1010. Advantageously, no compression is required in this embodiment. Each infrared transmitting material 1030 and 1040 may form a fluid seal. Advantageously such a configuration may give a good seal, and is easy to fit. Further the protrusion configuration of this embodiment is easy to manufacture and store. Similar embodiments may use only one preformed infrared transmitting material with protrusions where the protrusions correspond to the array of apertures of the grille. In some embodiments the preformed sheets of infrared transmitting material with protrusions on one side may be planar and smooth on the opposite side of the preformed sheet of infrared transmitting material. In some alternative embodiments the preformed sheets of infrared transmitting materials with protrusions on one side, may have corresponding indents on the opposite side of the sheet of infrared transmitting material.

A force may still be applied to compress this embodiment but it is not necessary to produce a seal or a complete infrared transmitting lens. Both sides of the grille need not be covered by an infrared transmitting material to produce an infrared transmitting lens. The infrared transmitting lens may comprise a sheet of infrared transmitting material wherein the infrared transmitting material comprises a preformed sheet of infrared transmitting material. Further the infrared transmitting material may comprise protrusions. The protrusions of the sheet of infrared transmitting material may correspond to the apertures of the grille.

In an alternative embodiment where a compression force is desired, the force used to compress the two sheets of infrared transmitting material 1030, 1040 into the grille 1010 may be between 15 and 40 Newtons of force. In this embodiment, the first infrared transmitting material 1030 on a front side of the grille 1010 deforms and partially fills the aperture between the bars of the grille 1010 from the front side. The second infrared transmitting material 1040 on the rear side of the grille 1010 deforms and partially fills the aperture of the grille 1010 from the rear side. In this particular embodiment, the first infrared transmitting material 1030 and the second infrared transmitting material 1040 deform and fill the aperture of the grille 1010 from their respective sides and contact in the middle of the aperture, thus, partially at least, filling the aperture. In other embodiments, the first infrared transmitting material 1030 and the second infrared transmitting material 1040 deform and partially fill the aperture of the grille 1010 from their respective sides and are separate from one another. Thus, the aperture remains partially filled. The width of both the first 1030 and second 1040 infrared transmitting material are equal, at 0.2 millimetres in diameter before compression. After compression the width of the first 1030 and second 1040 infrared transmitting material together, in total, is 0.4 millimetres at the aperture portion of the grille 1010. The grille 1010 has a width of 0.35 millimetres. In this FIG. 11 embodiment the infrared transmitting material 1030, 1040 coats the grille, thus offering protection against degradation, for example, corrosion. The grille 1010 gives structural protection to the infrared transmitting material and the infrared transmitting lens.

FIG. 12 shows an infrared transmitting lens 1100 according to a yet further embodiment. The infrared transmitting lens 1100 comprises a grille 1120 that is substantially the same as the grilles as described in FIGS. 9, 10 and 11, so will not be described again here in detail. The infrared transmitting lens 1100 further comprises a first infrared transmitting material 1130 positioned parallel and plush against a front side of the grille 1110 and a second infrared transmitting material 1140 positioned parallel and flush against a rear side of the grille 1110. The grille 1110 is formed from a network of bars. In this particular embodiment, the grille and bars comprise aluminium, however alternatively in other embodiments the bars may comprise a different material, such titanium or copper, plastic, plastic coated with a metal, or a different metal. The network of bars, which in this embodiment is aluminium, has an array of apertures 1120, however for simplicity, only one aperture 1120 is shown. In this embodiment, each of the first infrared transmitting material 1130 and the second infrared transmitting material 1140 are not compressed, and thus do not deform to fill the aperture 1120 of the grille 1110. In some embodiments an air gap may exists in the apertures 1120 of the grille 1110 between the first 1130 and second 1140 infrared transmitting materials. Both, the first 1030 and second 1040 infrared transmitting material is 0.2 millimetres in width. The grille 1110 is 0.5 millimetres in width. The first 1030 and second 1040 infrared transmitting material cover the grille 1110 protecting the grille 1110 from, for example, corrosion. The total width of the infrared transmitting lens of the FIG. 12 embodiment is 0.7 millimetres.

FIG. 13 shows an exploded view of an infrared transmitting lens 500 that, in this particular embodiment, uses double-sided adhesive-tape 555. An exploded view of FIG. 13 is shown to assist in understanding the component parts but in use the double-sided adhesive-tape 555 would contact both the grille 510 and the infrared transmitting material 550, 560; holding the infrared transmitting material 550, 560 to the grille 510. In this embodiment there are two infrared transmitting materials 550, 560, one on each side, or face, of the grille 510. In this embodiment the grille 510 comprises stainless steel, metal, to give strength and structural rigidity to the infrared transmitting lens 500. The grille 510 comprises an array of apertures 520 to enable the infrared light to pass through. The grille is 0.2 millimetres in width, from one side, or face, to the other side, or face, of the grille in this example. To each side, or face, of the grille there is a double-sided adhesive tape 555 with an array of apertures 557 that correspond to the array of apertures 520 of the grille 510. In the embodiment shown here, the corresponding array of apertures 557 of the double-sided adhesive-tape 555 is an exact, or almost exact, match to the array of apertures 520 of the grille 510. In this embodiment a jig (not shown) could be used to cut the array of apertures 557 of the double-side adhesive-tape 555. In other embodiments the corresponding array of apertures 557 of the adhesive tape 555 may not an exact match, for example the double-side adhesive tape may be only near the peripheral edge of the sides of the grille 510. In this FIG. 13 the central axis 570 is shown by a dashed line, however this dashed line does not exist in the embodiment.

Various modifications to the detailed designs are described above are envisaged. For example, previously it is described that the first infrared transmitting material and the second infrared transmitting material are compressed inwards towards the grille. This urges the first transmitting material and the second infrared transmitting material towards the grille and optionally, deforming the infrared transmitting material into the apertures of the grille. In some embodiments the grille may be formed by extrusion. In some embodiments, one or more, of the infrared transmitting material may be extruded around the grille. That is, the grille is produced by feeding a material such as, for example, aluminium, through an extruder along with infrared transmitting material on one or both sides of the grille. This produces an infrared transmitting lens having a grille and infrared transmitting material(s) in one step such that the grille is provided with infrared transmitting material(s) provided within, around or on, or any combination of within, on or around the grille, removing the need for a compression step to attachingly engage the infrared transmitting material with the grille. When the infrared transmitting material, for example, an infrared transmitting material comprising polymer, surrounds, or partially surrounds, the grille, the infrared transmitting material protects the grille from degradation, for example, from corrosion.

It will be clear to a person skilled in the art that features described in relation to any of the embodiments described above can be application interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Through the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect embodiment, or example described herein unless incompatible therewith. All of the features disclosed in this specification (including any accompanying claims, abstract or drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An infrared transmitting lens for mounting in an aperture of a housing containing an apparatus to be subjected to an infrared inspection, the infrared transmitting lens comprising:
a grille, the grille comprising a network of bars with an array of apertures between the bars, the grille providing mechanical protection to the infrared transmitting lens;
infrared transmitting material, positioned on both sides of the grille.

2. An infrared transmitting lens according to claim 1, wherein the grille further comprises infrared transmitting material between the network of bars of the grille, such that the infrared transmitting material, at least partially, fills the array of apertures between the network of bars of the grille.

3. An infrared transmitting lens according to claim 1, wherein the array of apertures of the grille are equal in size and shape, and arranged in a regular array.

4. An infrared transmitting lens according to claim 1, wherein the apertures of the grille are square, or circular; or rectangular; or triangular; or polygonal; or hexagonal; or any combination of square, circular, rectangular, triangular, polygonal or hexagonal.

5. An infrared transmitting lens according to claim 1, wherein the array of apertures of the grille are arranged in a tessellation.

6. An infrared transmitting lens according to claim 1, wherein the infrared transmitting lens is planar.

7. An infrared transmitting lens according to claim 1, wherein the infrared transmitting material comprises a polymer.

8. An infrared transmitting lens according to claim 1, wherein the grille comprises: plastic, or metal, or a combination of metal and plastic.

9. An infrared transmitting lens according to claim 1, wherein the grille is in the range of 0.2 millimetres to 3 millimetres wide from one side of the grille to the other side of the grille at a portion of the network of bars.

10. An infrared transmitting lens according to claim 1, wherein the infrared transmitting material, is in the range of 0.15 millimetres to 0.45 millimetres wide, in total, from one side to the other.

11. An infrared transmitting lens according to claim 1, wherein the infrared transmitting material in total width is 0.4 millimetres.

12. An infrared transmitting lens according to claim 1, wherein the infrared transmitting material is nonplanar.

13. An infrared transmitting lens according to claim 1, wherein the infrared transmitting material forms a seal across the infrared transmitting lens, or the grille, such that the seal is impermeable to fluids.

14. An infrared transmitting lens according to claim 1, wherein the infrared transmitting material comprises protrusions.

15. An infrared transmitting lens according to claim 1, wherein further comprises double-sided adhesive-tape on, a portion, of both sides of the grille, the double-sided adhesive-tape is between the grille and the infrared transmitting material.

16. An infrared transmitting lens for mounting in an aperture of a housing containing an apparatus to be subjected to an infrared inspection, the infrared transmitting lens comprising: a grille, the grille comprising a network of bars with an array of apertures between the bars, the grille further comprising infrared transmitting material between the bars of the grille, such that the infrared transmitting material, at least partially fills, the array of apertures between the bars of the grille.

17. An infrared transmitting lens according to claim 16, wherein further comprises, infrared transmitting material on one side of the grille.

18. A method of manufacturing an infrared transmitting lens for mounting in an aperture of a housing containing an apparatus to be subjected to infrared inspection, comprising the steps of:
providing a grille, wherein the grille comprises a network of bars with an array of apertures between the network of bars;
providing an infrared transmitting material to a first side of the grille; and,
providing an infrared transmitting material to a second side of the grille.

19. A method of manufacturing an infrared transmitting lens according to claim 18 wherein further comprising the step of: applying double-sided adhesive-tape to, a portion of the network of bars of the grille, on both sides of the grille, before; providing an infrared transmitting material to a first side of the grille and providing an infrared transmitting material to a second side of the grille.
